(19) United States
(12) Patent Application Publication
(10) Pub. No.: US 2025/0285354 A1
(43) Pub. Date: Sep. 11, 2025

(54) SYSTEM, AND SYSTEM CONTROL METHOD FOR CONTROLLING DISPLAY OF AVATAR OF USER

(71) Applicant: CANON KABUSHIKI KAISHA, Tokyo (JP)

(72) Inventors: HIROTO OKA, Kanagawa (JP); KAZUYA SHINOZAKI, Tokyo (JP); YASUHIRO SHIRAISHI, Kanagawa (JP)

(21) Appl. No.: 19/219,918

(22) Filed: May 27, 2025

Related U.S. Application Data
(63) Continuation of application No. PCT/JP2023/032738, filed on Sep. 7, 2023.

(30) Foreign Application Priority Data
Nov. 29, 2022 (JP) 2022-190101

(51) Int. Cl. G06T 13/40; G06V 20/20; G06V 40/16

(52) U.S. Cl. CPC G06T 13/40; G06V 20/20; G06V 40/176

(57) ABSTRACT

A system according to the present invention is a system for realizing communication between a first user and a second user, the system including one or more processors and/or circuitry configured to execute acquiring processing of acquiring real-time information of the first user, and execute control processing of controlling, on a display apparatus which belongs to the second user and which displays a virtual space including a first avatar of the first user, reflection of the real-time information of the first user in a facial expression of the first avatar, wherein in the control processing, the real-time information of the first user is reflected in the facial expression of the first avatar by emphasizing or suppressing the real-time information based on at least one of a purpose of the communication and information on the second user.

### CROSS-REFERENCE TO RELATED APPLICATIONS

This application is a Continuation of International Patent Application No. PCT/JP2023/032738, filed Sep. 7, 2023, which claims the benefit of Japanese Patent Application No. 2022-190101, filed Nov. 29, 2022, all of which are hereby incorporated by reference herein in their entirety.

### BACKGROUND OF THE INVENTION

### Field of the Invention

The present invention relates to a system for controlling display of an avatar of a user and to a method of controlling the system.

### Background Art

With the development and widespread use of virtual reality (VR) technology, the use of the technology for various purposes (distribution, business, medical, and the like) is being considered. In VR, a user generally uses an avatar (an alter ego of the user in the system) to communicate in the virtual space.

On the other hand, techniques already exist that use a camera or a wearable device to acquire physical information on the user (such as a facial expression, a motion, vitals, or brain waves of the user). Therefore, it is conceivable to reflect the physical information of the user in a facial expression or a motion of the avatar.

PTL 1 describes a technique that detects a motion, a facial expression, or five senses of a user who is a distributor, and when it is determined that a detection result satisfies a predetermined condition, an avatar's facial expression is changed to a predetermined facial expression and the avatar's pose is changed to a predetermined pose.

However, it may not be appropriate to uniformly change the facial expression and the pose of an avatar when it is determined that a detection result of a motion or the like satisfies a predetermined condition. For example, in a general meeting (such as a business negotiation or a negotiation), it is not always desirable to have the avatar change facial expressions to make the patient's tic or other symptoms or negative emotions clear to others.

### CITATION LIST

### Patent Literature

PTL 1 Japanese Patent Application Laid-open No. 2021-189674

### SUMMARY OF THE INVENTION

Therefore, the present invention provides a technique to more appropriately control reflection of user information in an avatar.

The present invention in its one aspect provides a system for realizing communication between a first user and a second user, the system including one or more processors and/or circuitry configured to execute acquiring processing of acquiring real-time information of the first user, and execute control processing of controlling, on a display apparatus which belongs to the second user and which displays a virtual space including a first avatar of the first user, reflection of the real-time information of the first user in a facial expression of the first avatar, wherein in the control processing, the real-time information of the first user is reflected in the facial expression of the first avatar by emphasizing or suppressing the real-time information based on at least one of a purpose of the communication and information on the second user.

The present invention in its one aspect provides a system control method for realizing communication between a first user and a second user, the system control method including acquiring real-time information of the first user, and controlling, on a display apparatus which belongs to the second user and which displays a virtual space including a first avatar of the first user, reflection of the real-time information of the first user in a facial expression of the first avatar, wherein the real-time information of the first user is reflected in the facial expression of the first avatar by emphasizing or suppressing the real-time information based on at least one of a purpose of the communication and information on the second user.

Further features of the present invention will become apparent from the following description of exemplary embodiments with reference to the attached drawings.

### BRIEF DESCRIPTION OF THE DRAWINGS

FIG. 1 is a configuration diagram of a communication system according to a first embodiment;

FIG. 2 is a configuration diagram of a user terminal according to the first embodiment;

FIG. 3 is a configuration diagram of a server PC according to the first embodiment;

FIG. 4 is a diagram showing a setting UI according to the first embodiment;

FIGS. 5A to 5C are diagrams describing group counseling according to the first embodiment;

FIG. 6A is a flow chart of processing using remote rendering according to the first embodiment;

FIG. 6B is a flow chart of processing using local rendering according to the first embodiment;

FIGS. 7A to 7C are diagrams showing a setting UI according to a second embodiment;

FIGS. 8A to 8C are diagrams representing an appearance of avatars in a virtual space according to the second embodiment;

FIG. 9 is a flow chart of processing according to the second embodiment;

FIG. 10 is a configuration diagram of a communication system according to a third embodiment;

FIG. 11 is a flow chart of processing according to the third embodiment;

FIGS. 12A and 12B are diagrams representing an appearance of avatars in a virtual space according to a fourth embodiment; and

FIG. 13 is a flow chart of processing according to the fourth embodiment.

### DESCRIPTION OF THE EMBODIMENTS

Hereinafter, embodiments of the present invention will be described in detail with reference to the accompanying drawings.

### First Embodiment

In a first embodiment, a communication system built as a client-server system will be described.

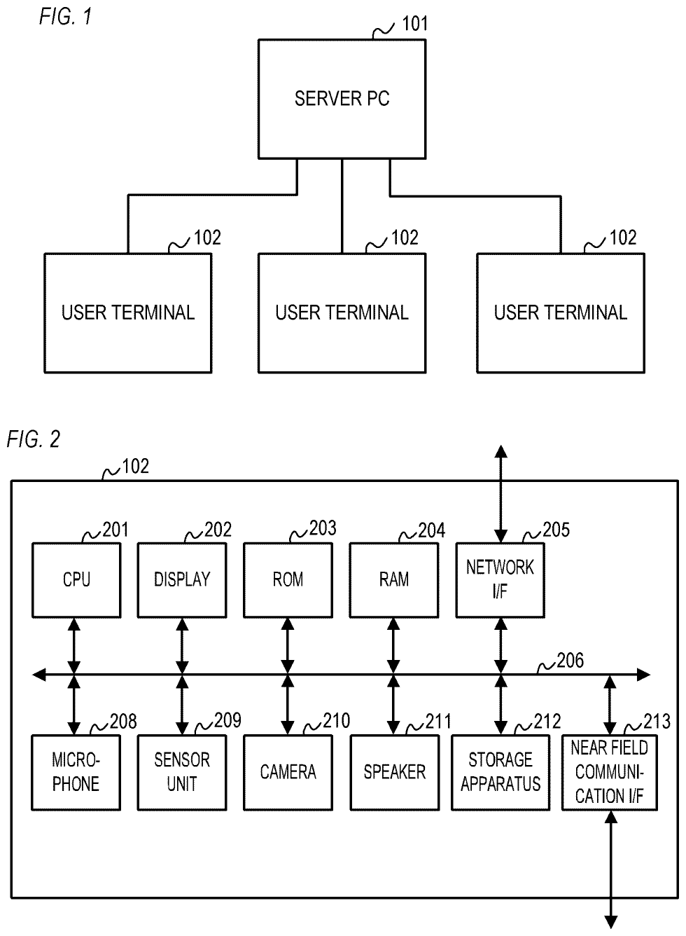

FIG. 1 is an overall configuration diagram of the communication system according to the first embodiment. The communication system includes a server PC 101 and a plurality of user terminals 102 (terminals connected to the server PC 101 by a network such as the Internet).

Each user terminal 102 is a display apparatus such as a PC, a smartphone, a tablet, or an HMD (head mounted display). The user terminal 102 may be a controller (control apparatus) capable of controlling such display apparatuses. Hereinafter, a case where the user terminal 102 is an HMD will be described. Note that while a case where the HMD can be directly connected to the network will be described in the first embodiment, the HMD can be connected to the network via another device (a PC, a smartphone, or the like).

FIG. 2 shows an example of a hardware configuration diagram of the user terminal 102 according to the first embodiment. The user terminal 102 includes a CPU 201, a display 202, a ROM 203, a RAM 204, a network I/F 205, and an internal bus 206. The user terminal 102 includes a microphone 208, a sensor unit 209, a camera 210, a speaker 211, a storage apparatus 212, and a near field communication I/F 213.

The CPU 201 is a control unit that comprehensively controls various functions of the user terminal 102 via the internal bus 206 by programs stored in the ROM 203. Results of program execution by the CPU 201 can be viewed by the user by having the results be displayed by the display 202.

The ROM 203 is a flash memory or the like. The ROM 203 stores various setting information, application programs as described earlier, and the like. The RAM 204 functions as a memory and a work area of the CPU 201.

The network I/F (interface) 205 is a module for connecting to the network. The microphone 208 acquires voice uttered by the user.

The sensor unit 209 includes one or more sensors. Specifically, the sensor unit 209 includes at least any of a GPS, a gyro sensor, an accelerometer, a proximity sensor, and a metering sensor (a sensor that measures blood pressure, heart rate, or brain waves). In addition, the sensor unit 209 may be implemented with a sensor to detect body information (information about the body; biometric information) to achieve authentication (fingerprint authentication, vein authentication, iris authentication, or the like).

The camera 210 is a fisheye camera (imaging unit) mounted inside the HMD. The camera 210 can acquire a photographed image of the user's face. The photographed image is stored in the RAM 204 after distortion due to the fisheye lens is removed.

The speaker 211 reproduces voices of users participating in the communication system, sound effects, BGM, and the like.

The storage apparatus 212 is a storage medium. In addition, the storage apparatus 212 is an apparatus that stores various kinds of data of applications and the like.

The near field communication I/F 213 is an interface used in communication with the user's controller. The user can input a gesture to the user terminal 102 by moving the controller being held by the user. In addition, the user can issue an instruction to the user terminal 102 by operating a button, a joystick, or the like provided in the controller. The controller may include sensors that measure a heart rate, pulse, perspiration, and the like of the user. In addition, the near field communication I/F 213 may communicate with a wearable device worn by the user to obtain the heart rate, the pulse, the perspiration, and the like of the user. Furthermore, the near field communication I/F 213 may communicate with an apparatus (a camera, a sensor group, or the like) installed inside a room where the user is present.

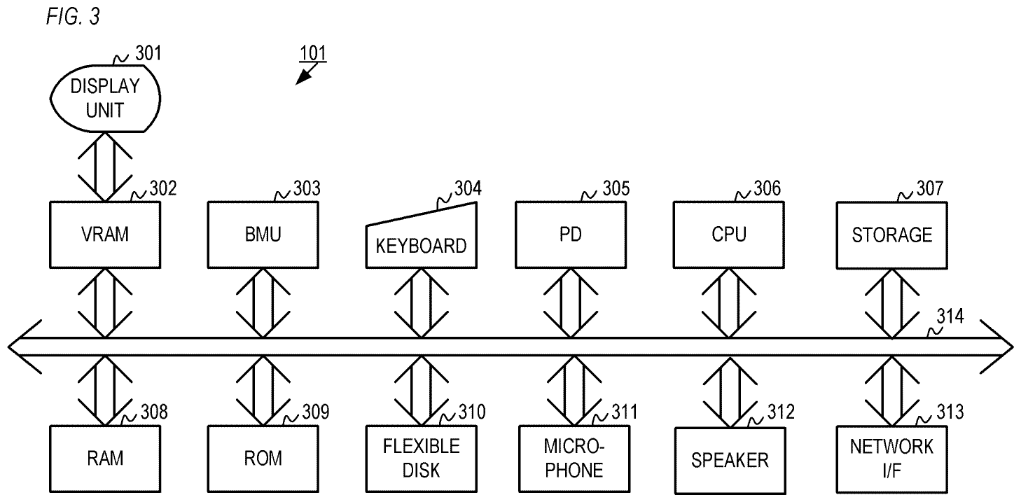

FIG. 3 shows an example of a hardware configuration diagram of the server PC 101 according to the first embodiment.

As shown in FIG. 3, the server PC 101 includes a display unit 301, a VRAM 302, a BMU 303, a keyboard 304, a PD 305, a CPU 306, a storage 307, a RAM 308, a ROM 309, and a flexible disk 310. The server PC 101 includes a microphone 311, a speaker 312, a network I/F 313, and a bus 314.

For example, the display unit 301 displays a live view image, an icon, a message, a menu, or other user interface information.

A moving image to be displayed on the display unit 301 is drawn in the VRAM 302. Data of the moving image generated in the VRAM 302 is transferred to the display unit 301 in accordance with prescribed regulations and thereby displayed on the display unit 301.

The BMU (bit move unit) 303 controls data transfer between, for example, a plurality of memories (for example, the VRAM 302 and another memory). In addition, the BMU (bit move unit) 303 controls data transfer between, for example, a memory and each I/O device (for example, the network I/F 313).

The keyboard 304 includes various kinds of keys for the user to input characters and the like.

For example, the PD (pointing device) 305 is used to issue an instruction with respect to a content (an icon, a menu, or the like) or to drag and drop an object displayed on the display unit 301.

The CPU 306 is a control unit that controls each component based on an OS and programs (control programs) stored in the storage 307, the ROM 309, or the flexible disk 310.

The storage 307 is an HDD (hard disk drive) or an SSD (solid state drive). The storage 307 stores various control programs, various kinds of data to be temporarily stored, and the like.

The RAM 308 includes a work area for the CPU 306, an area for saving data during error processing, an area for loading control programs, and the like.

The ROM 309 stores various control programs used in the server PC 101, data to be temporarily stored, and the like.

The flexible disk 310 stores various control programs, various kinds of data (data that needs to be temporarily stored), and the like.

The microphone 311 acquires sound around the server PC 101. The speaker 312 outputs sound included in data of a moving image.

The network I/F 313 communicates with the user terminal 102 via the network. The bus 314 includes an address bus, a data bus, and a control bus.

Control programs can be provided to the CPU 306 from the storage 307, the ROM 309, or the flexible disk 310 or from another information processing apparatus or the like via the network through the network I/F 313.

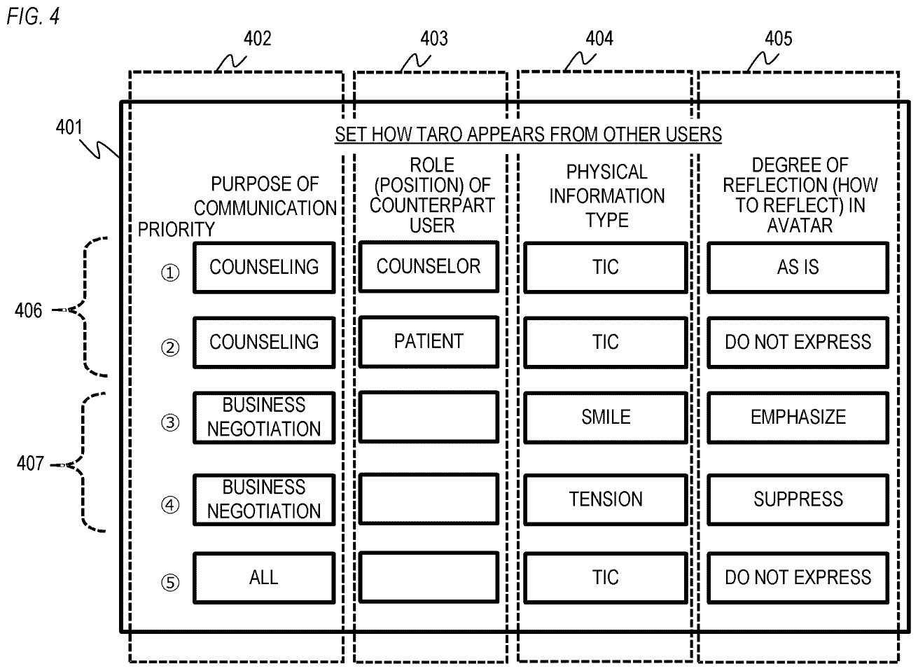

FIG. 4 is a diagram showing a setting UI (user interface) 401 of the communication system according to the first embodiment. The setting UI 401 is displayed on the display 202 of the user terminal 102. The user uses the setting UI 401 to set how the user's physical information (information about the body; biometric information) including the user's symptoms is to be reflected in the user's avatar and conveyed to other users (reflection setting). In FIG. 4, five settings are displayed, each with priorities of 1 to 5. In addition, in the setting UI 401, UI areas 402 to 404 each indicate a condition and a UI area 405 indicates processing when the conditions are satisfied.

Hereinafter, the user for whom the reflection setting is configured will be referred to as a “first user” and another user (a user other than the first user and participating in a same virtual space community as the first user) will be referred to as a “counterpart user”. In addition, an avatar of the first user will be referred to as a “used avatar”.

The UI area 402 is a UI area for setting a purpose of communication (for example, performing counseling or engaging in a business negotiation).

The UI area 403 is a UI area for setting a role of the counterpart user (for example, a counselor or a patient). Note that a case where nothing is entered in the UI area 403 indicates that the role of the counterpart user may be any role.

The UI area 404 is a UI area for setting a type of physical information (physical information type) to be reflected in the avatar. Examples of a physical information type include a tic, a smile, and tension. A tic refers to a sudden body motion or vocalization that occurs unintentionally.

The UI area 405 is a UI area for setting a degree of reflection (reflection method) of physical information indicated by the physical information type to the avatar. When reflecting the user's facial expression or the like in the avatar, the user can select one of the following options: “reflect as is”, “reflect with emphasis”, “reflect with suppression”, or “do not reflect.

For example, let us assume a case where group counseling on tic symptoms is conducted in a virtual space. “Group counseling” refers to a counseling technique in which a plurality of patients are brought together. In this case, a plurality of users with different roles (positions) of counselors and patients participate in a community (group) in the virtual space. The first user who is a patient may be conscious about his or her tic symptoms and may not want other patients to see the tic symptoms. In this case, for example, the first user adopts a setting so that “if the purpose of communication is to conduct counseling, the tic is not reflected in a used avatar to be shown to a counterpart user whose role is that of a patient” (adopt setting with a priority of 2) as shown in a setting group 406. In addition, the first user adopts a setting so that “if the purpose of communication is to conduct counseling, the tic is reflected in a used avatar to be shown to a counterpart user whose role is that of a counselor” (adopt setting with a priority of 1).

In other words, when reflecting his/her symptoms in a used avatar, the first user can set whether the symptoms are to be shown (and how much the symptoms are to be shown) in accordance with a role of a counterpart user to which the used avatar is to be shown.

Furthermore, for example, let us assume a case where in engaging in a business negotiation in a virtual space, the first user wishes his/her used avatar to reflect friendly facial expressions (such as smiles) in an emphasized manner in order to relax the counterpart's guard and, conversely, to reflect tension in a suppressed manner. In this case, the first user can adopt a setting so that “if the purpose of communication is to engage in a business negotiation, the used avatar to be shown to the counterpart user reflects smiles of the first user in an emphasized manner and reflects tension of the first user in a suppressed manner” as shown in a setting group 407.

Note that in the setting UI 401, a physical information type and a reflection degree to an avatar may be set in advance for each purpose of communication.

In addition, among the plurality of settings entered in the setting UI 401, the communication system preferentially uses a setting with a smaller assigned priority number. For example, let us assume a case where, in the example shown in FIG. 4, the purpose of communication is to conduct counseling, the role of the counterpart user is that of a counselor, and reflection of tic in the used avatar is to be controlled. In this case, while settings with priorities of 1 and 5 can be used, the communication system uses the setting with the lower priority (in other words, the setting with the priority of 1). Therefore, the communication system exerts control so that symptoms of tic occurring on the first user are reflected “as is” in the used avatar.

Furthermore, the communication system may have a used avatar reflect not only visible information such as a facial expression or a motion of the first user but also other information. For example, when remote medical treatment or counseling is conducted in a virtual space, the user terminal 102 acquires a patient's body temperature or heartbeat with the sensor unit 209 or eye motions with the camera 210. In addition, the user terminal 102 may estimate the degree of tension or calmness of the first user based on the acquired information and reflect the results of the estimation in the avatar.

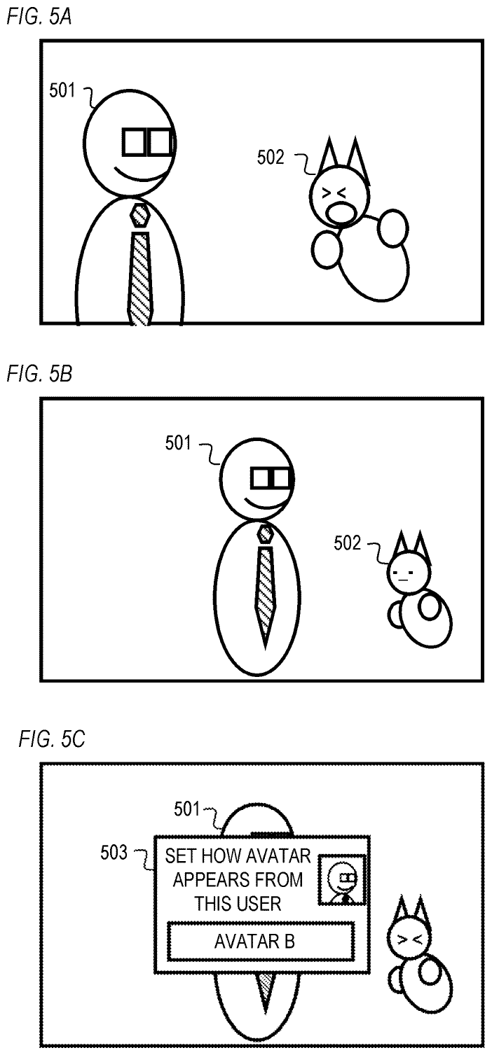

While the setting UI described above is intended to be used before the first user joins a community (group) in the virtual space, there may also be a UI that is set while the first user is viewing the virtual space. Such a UI will be described later with reference to FIG. 5C.

FIGS. 5A to 5C are diagrams representing group counseling in a virtual space. In this case, let us assume that a patient A has adopted a setting so that “if the purpose of communication is to conduct counseling, the tic is not reflected in a used avatar to be shown to a counterpart user whose role is that of a patient”. In addition, let us assume that the patient A has adopted a setting so that “if the purpose of communication is to conduct counseling, the tic is reflected in a used avatar to be shown to a counterpart user whose role is that of a counselor”. Furthermore, let us assume that four participants are participating in the group counseling: a main counselor, a sub counselor, the patient A, and a patient B. Note that an avatar 501 is the avatar of the main counselor and an avatar 502 is the avatar of the patient A.

FIG. 5A represents a virtual space displayed on the user terminal 102 of the sub counselor and FIG. 5B represents a virtual space displayed on the user terminal 102 of the patient B. Note that the virtual space displayed on the user terminal 102 of the sub counselor represents a space (field of view) that is visible from the avatar of the sub counselor. Note that the virtual space displayed on the user terminal 102 of the patient B represents a space that is visible from the avatar of the patient B.

In this case, the avatar of the sub counselor and the avatar of the patient B are positioned at different locations in the virtual space. Therefore, a range of displayed avatars (the avatar 501 of the main counselor and the avatar 502 of the patient A) differs between the user terminal 102 of the sub counselor and the user terminal 102 of the patient B. It is assumed that the avatar of the patient B is not included in the display of the user terminal 102 of the sub counselor. It is assumed that the avatar of the sub counselor is not included in the display of the user terminal 102 of the patient B.

Now, let us assume a case where a frowning motor tic occurs in the patient A during counseling. Since information on the motor tic is necessary for the counselor, as shown in FIG. 5A, the avatar 502 of the patient A is frowning in the virtual space being viewed by the sub counselor (the motor tic of the patient A is reflected in the avatar 502 of the patient A). In a similar manner, the avatar 502 of the patient A is also frowning in the virtual space being viewed by the main counselor.

On the other hand, as shown in FIG. 5B, the facial expression of the avatar 502 of the patient A does not change in the virtual space being viewed by the patient B. This is because the patient A has adopted a setting so that “the tic is not reflected in a used avatar to be shown to a counterpart user whose role is that of a patient” as shown in the setting group 406.

FIG. 5C is another example of an UI to be used by the first user to set “how the used avatar is to be shown to a counterpart user in a virtual space”. For example, using a controller or the like, the patient B selects the avatar 501 of the main counselor and subsequently issues an instruction to set up how his/her avatar is to be shown. Consequently, a setting screen 503 is displayed in the virtual space. The patient B uses the setting screen 503 to set how his/her avatar will appear to the main counselor. Accordingly, the first user can readily change the setting even when the virtual space is being displayed.

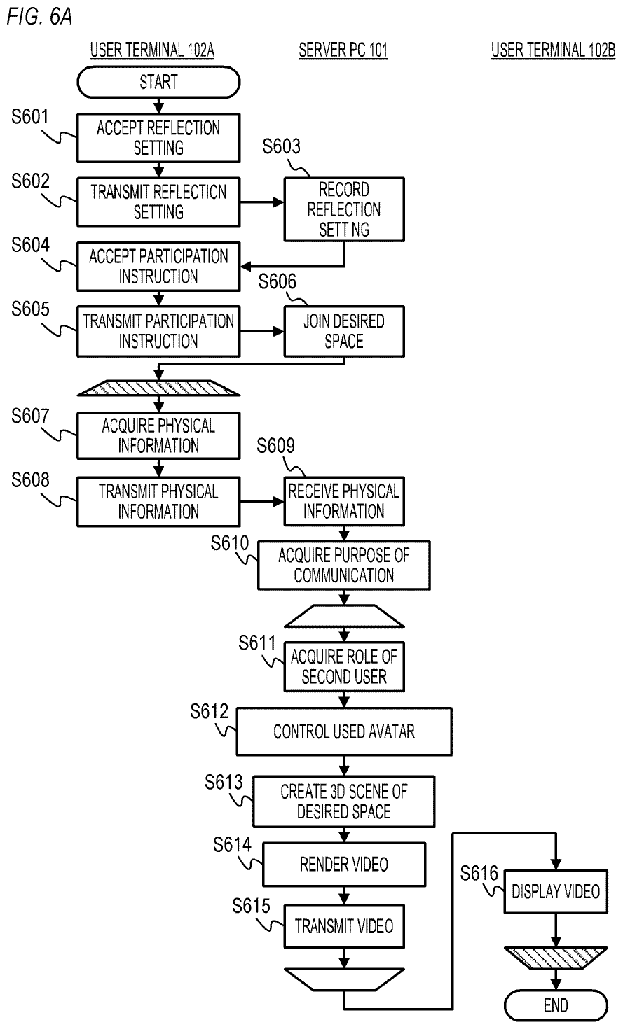

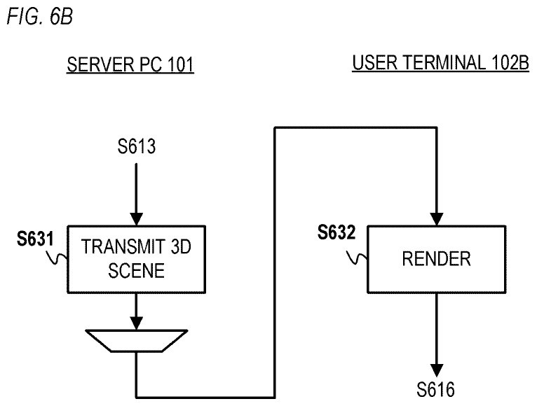

The flow charts in FIGS. 6A and 6B show processing by the communication system according to the first embodiment. The flowchart in FIG. 6A shows processing using a method in which the server PC 101 renders a video displayed on each user terminal 102 (a method referred to as remote rendering). On the other hand, FIG. 6B shows processing using a method in which the user terminal 102 renders a video (a method referred to as local rendering). The communication system according to the first embodiment is capable of executing either of these two kinds of processing.

The processing using remote rendering will be described with reference to the flow chart shown in FIG. 6A.

Steps S601 to S603 represent processing by the first user to set how physical information of the first user is reflected in his/her used avatar. Note that the processing is executed between the user terminal 102 of all users who join a community in virtual space and the server PC 101. Hereinafter, the user terminal 102 of the first user will be referred to as a “user terminal 102A” and each component of the user terminal 102A will be suffixed with “A”. For example, the display 202 of the user terminal 102A will be referred to as a “display 202A” and the CPU 201 of the user terminal 102A will be referred to as a “CPU 201A”.

In step S601, the CPU 201 (CPU 201A) of the user terminal 102A accepts a reflection setting (a setting with respect to how the physical information of the first user is to be reflected in the used avatar and conveyed to a counterpart user) from the first user. Specifically, the CPU 201A acquires, as the reflection setting, a setting entered by the user in the setting UI shown in FIG. 4 (a setting that mutually associates a purpose of communication, a role of a counterpart user, a physical information type, and a degree of reflection).

In step S602, the CPU 201A transmits the accepted reflection setting to the server PC 101.

In step S603, the CPU 306 of the server PC 101 records (stores) the received reflection setting in the storage 307 or the like.

The subsequent steps S604 to S606 represent processing by the first user to join a community in virtual space. Although omitted in FIG. 6A, the processing is executed between the user terminal 102 of all users who join a community in the virtual space and the server PC 101.

In step S604, the CPU 201A accepts a participation instruction to the community in the virtual space from the first user. At this point, the CPU 201A acquires identification information of the virtual space (hereinafter, referred to as a “desired space”) of the community which the first user desires to join.

In step S605, the CPU 201A transmits the identification information of the desired space to the server PC 101 to request participation in the community in the desired space.

In step S606, the CPU 306 enlists the first user to the community in the desired space which corresponds to the acquired identification information.

The subsequent steps S607 to S616 represent processing (loop processing) to be executed repeatedly. The loop processing is repeated until all users including the first user leave the community in the desired space.

In step S607, the CPU 201A acquires real-time (present) physical information of the first user. For example, the CPU 201A acquires at least any of the following pieces of physical information: voice, emotion, facial expression, blood pressure, heart rate, stress level, body temperature, amount of perspiration, brain waves, pulse rate, posture, and motion (including eye motion). For example, the CPU 201A may acquire a photographed image of the first user as physical information.

For example, the CPU 201A controls the microphone 208A to acquire voice uttered by the first user. In this case, the CPU 201A may further use existing techniques for analyzing voice emotion to estimate the emotion of the first user from the acquired voice.

The CPU 201A may control the camera 210A to acquire a photographed image of the user's face. In this case, the CPU 201A may use a facial expression analyzing technique to analyze (acquire) a facial expression of the first user based on the photographed image. In addition, the CPU 201A may analyze an eye motion of the first user based on the photographed image to estimate psychology of the first user. Furthermore, the CPU 201A may use a vital data analyzing technique to estimate the blood pressure, the heart rate, and/or the stress level of the first user.

In addition, the CPU 201A may control the sensor unit 209A and measure at least any of the blood pressure, the heart rate, the body temperature, the amount of perspiration, the brain waves, and the like of the first user.

The CPU 201A may use the near field communication I/F 213 to communicate with a controller being held by the first user or a wearable device being worn by the first user. The CPU 201A may acquire information (any of the heart rate, the body temperature, the amount of perspiration, the brain waves, and the like of the first user) acquired by the controller or the wearable device. The CPU 201A may use the near field communication I/F 213 to communicate with a camera installed inside a room or the like to acquire a photographed image of the first user taken by the camera. In addition, the CPU 201A may acquire posture information or motion operation of the first user based on the photographed image.

The CPU 201A may use the near field communication I/F 213 to connect with a sensor group installed inside the room in which the first user is present to acquire vital information of the user.

In step S608, the CPU 201A transmits the physical information of the first user acquired in step S607 to the server PC 101.

Note that in step S607, when the CPU 201A determines that the first user having tic symptoms has frowned, the CPU 201A may determine that a motor tic has occurred in the first user. In addition, based on an eye motion of the first user with a condition of dizziness, the CPU 201A may determine whether or not the first user is experiencing dizziness. In other words, the CPU 201A may refer to information (disease information) indicating a disease of the first user to determine whether or not symptoms have appeared in the first user. Furthermore, based on a determination result as to whether or not symptoms have appeared in the first user, the CPU 201A may control how physical information such as a motor tic or dizziness is reflected in the used avatar.

For example, when the CPU 201A determines that a disease indicated by the disease information of the first user has appeared in the first user, in step S608, the CPU 201A may transmit physical information (for example, information on a frowning behavior) related to the symptom of the first user. On the other hand, when the CPU 201A determines that a disease indicated by the disease information of the first user has not appeared in the first user, in step S608, the CPU 201A may not transmit physical information related to the symptom of the first user. Accordingly, when it is determined that a symptom indicated by the disease information of the first user has appeared in the first user, physical information related to the symptom can be arranged to be reflected in the used avatar in step S612 to be described later. On the other hand, when it is determined that a symptom indicated by the disease information of the first user has not appeared in the first user, physical information related to the symptom can be arranged to be not reflected in the used avatar in step S612 to be described later. In other words, even when a same facial expression of a frowning face appears, whether or not the facial expression is to be conveyed to a counterpart user by reflecting the facial expression in the used avatar can be changed depending on the disease of the first user.

In step S609, the CPU 306 of the server PC 101 receives the physical information of the first user.

In step S610, the CPU 306 acquires (determines) a purpose of communication performed in the desired space.

For example, the CPU 306 acquires a purpose of communication entered by any user (any of the users participating in a community in the desired space) using a UI displayed on the user terminal 102.

In addition, when a purpose of communication is linked with information forming the desired space (for example, when information on “a virtual space for counseling” is linked with information forming the desired space), the CPU 306 may determine the purpose from the information. The CPU 306 may estimate (determine) a purpose of communication based on information on an account of at least any of a plurality of users participating in a community in the desired space. For example, when a user with an account of a counselor is participating in a community in the desired space, the CPU 306 may estimate the purpose of communication to be “conduct counseling”.

The CPU 306 may analyze an outward appearance of each avatar in the desired space to estimate a purpose of communication. For example, when an avatar wearing a white coat is present in the desired space, the CPU 306 may estimate the purpose of communication to be “conduct a medical examination or counseling”.

Processing of subsequent steps S611 to S615 is loop processing which is repeated as many times as the number of users (other than the first user) who participate in the community and view a video of the desired space (virtual space). Hereinafter, one user among the users viewing the video of the desired space will be referred to as a “second user”. Hereinafter, the user terminal 102 of the second user will be referred to as a “user terminal 102B” and each component of the user terminal 102B will be suffixed with “B”. For example, the display 202 of the user terminal 102B will be referred to as a “display 202B” and the CPU 201 of the user terminal 102B will be referred to as a “CPU 201B”.

In step S611, the CPU 306 determines (confirms) a role (position) of the second user.

For example, the CPU 306 acquires information of the role of the second user based on information on the account of the second user. For example, when the purpose of communication is to conduct counseling, the CPU 306 determines whether or not the role of the second user is that of a counselor based on information on the account of each user managed by the communication system.

The CPU 306 may determine the role of the second user based on information acquired from an external system. For example, the CPU 306 queries an electronic medical record system in a hospital to determine, based on a result of the query, whether or not the role of the second user is that of a counselor (whether or not the second user is registered as a counselor).

For example, when the first user is capable of setting a role of a counterpart user participating in a community in the desired space, the CPU 306 may refer to the setting information to determine the role of the second user. With this method, for example, the first user who is a patient may classify the second user who is a counselor as either a “trustworthy counselor” or an “untrustworthy counselor”. In this case, the CPU 306 may exert control so that tic symptoms of the first user are reflected in a used avatar to be seen by the “trustworthy counselor” but the tic symptoms of the first user are not reflected in a used avatar to be seen by the “untrustworthy counselor”.

In step S612, the CPU 306 controls the used avatar of the first user based on the physical information of the first user, the purpose of communication, and the role of the second user.

Processing of step S612 will be described using a case where the first user exhibits a motor tic (a motor tic involving frowning) as an example.

For example, let us assume a case where, in step S607, the CPU 201A controls the camera 210 to acquire a photographed image of the face of the first user. In this case, in step S607, the CPU 201A analyzes a facial expression from the photographed image to acquire information as to whether or not the first user has frowned. Furthermore, given that the user has tic symptoms, the CPU 201A acquires information indicating that a motor tic has been exhibited as the physical information of the first user. In addition, in step S608, the CPU 201A transmits the physical information of the first user to the server PC 101 via the network I/F 205.

As a result, in step S612, the CPU 306 refers to the reflection setting of the first user recorded in step S603. Now, as shown in FIG. 4, let us assume that the settings of the first user involve “in counseling, reflecting tic in avatar to be viewed by a user who is a counselor but not reflecting tic in avatar to be viewed by a user who is a patient”. In addition, information has been acquired which indicates that a motor tic has been exhibited as the physical information of the first user. Therefore, according to the reflection setting, the CPU 306 controls the avatar of the first user so as to frown when the purpose of communication is to conduct counseling and the role of the second user is that of a counselor. On the other hand, the CPU 306 controls the avatar of the first user so as not to frown when the purpose of communication is not to conduct counseling or the role of the second user is that of a patient.

In step S613, the CPU 306 generates a 3D scene of the desired space including the avatar of the first user controlled in step S612. For example, the CPU 306 generates the 3D scene in a data format (such as X3D) capable of describing three-dimensional computer graphics.

In step S614, the CPU 306 renders the 3D scene of the desired space and generates a video of the desired space as viewed from the avatar (a viewpoint of the avatar) of the second user. In this case, the CPU 306 generates the video in a data format such as MP4.

In step S615, the CPU 306 transmits the video generated in step S614 to the user terminal 102B.

In step S616, the CPU 201B receives the video. The CPU 201B displays the video on the display 202B.

Next, the processing using local rendering will be described with reference to the flow chart shown in FIG. 6B. When processing using local rendering is performed (when processing shown in FIG. 6B is performed), steps S614 and S615 shown in FIG. 6A are replaced by steps S631 and S632. On the other hand, processing in the other steps (steps S601 to S613 and S616) when using local rendering is performed in a similar manner to when using remote rendering (the case shown in FIG. 6A). Therefore, hereinafter, only steps S631 and S632 will be described.

In step S631, the CPU 306 transmits the 3D scene generated in step S613 to the user terminal 102B.

In step S632, the CPU 201B renders the received 3D scene of the desired space and subsequently generates a frame of a video of the desired space as viewed from the avatar of the second user.

As described above, due to the communication system operating according to the reflection setting described with reference to FIG. 4, for example, a situation where the avatar of the patient A only frowns in a virtual space observed by a counselor can be realized. In other words, a used avatar can be more appropriately controlled based on the role of a counterpart user and a purpose of communication.

Note that in the description given above, for the sake of simplicity, the processing of generating the 3D scene in the virtual space in steps S612 to S613 is performed in a case where the second user is a main counselor and in a case where the second user is a sub counselor, respectively. However, in reality, the processing will be more efficient if the 3D scene in the virtual space generated in steps S611 to S612 is reused for a plurality of counterpart users whose roles are the same.

### Second Embodiment

In the first embodiment, an example was shown in which a degree of reflection of physical information in a used avatar is set by having the first user configure a reflection setting of associating a purpose of communication and a degree of reflection of the physical information with each other. However, depending on the purpose of communication, a user in a particular role (position) may wish to determine a degree to which physical information of another user is to be reflected. For example, in group counseling, when a patient with severe tic symptoms and a patient with mild tic symptoms are present, the counselor may want to make the symptoms of the patient with mild tic symptoms more noticeable. In consideration thereof, in the second embodiment, a communication system that enables a given user to set a degree to which physical information is reflected in an avatar of another user will be described.

In a similar manner to the first embodiment, let us assume that four participants are participating in the group counseling (community) in a virtual space: a main counselor, a sub counselor, a patient A, and a patient B. Let us also assume that the patient A is a severe patient with a severe motor tic response and the patient B is a mild patient with a mild motor tic response. Note that in the second embodiment, the communication system (CPU 306) increases a size of an avatar of a user when a motor tic response of the user is severe (in accordance with a severity of the motor tic response).

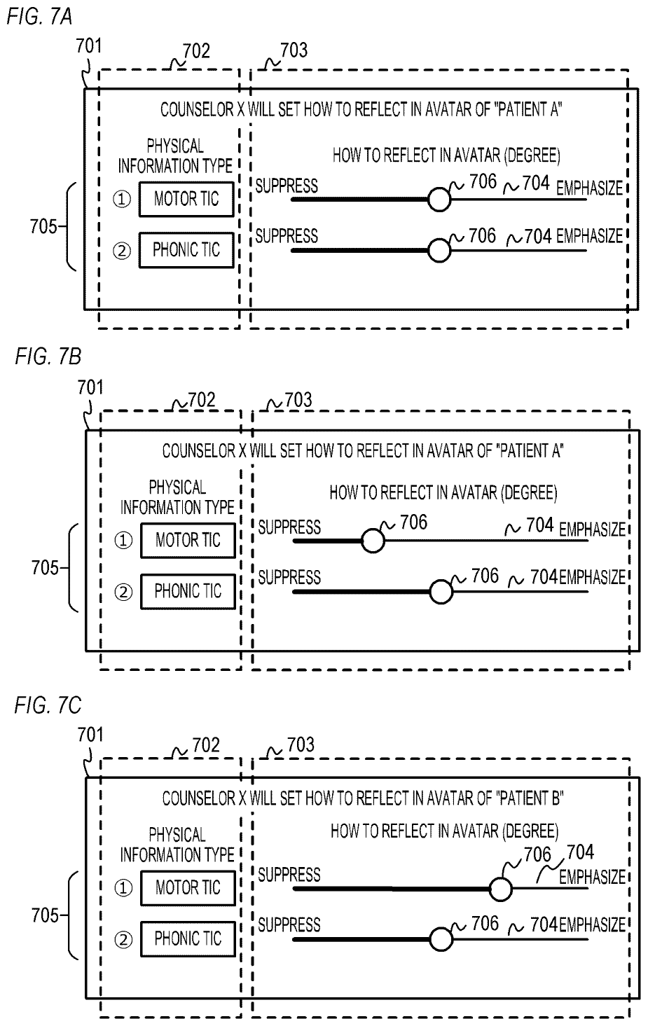

FIGS. 7A to 7C are diagrams showing an example of a setting UI according to the second embodiment. A setting UI 701 is displayed on the user terminal 102 of a counselor. The counselor uses the setting UI 701 to set how physical information of a patient (including symptoms of the patient) is to be displayed on the counselor's user terminal 102 (configure the reflection setting).

A UI area 702 is an area representing a physical information type. In FIGS. 7A to 7C, motor tic and phonic tic are selected as physical information types.

A UI area 703 is a UI area for setting a degree of reflection of physical information to an avatar. In FIGS. 7A to 7C, a slide bar 704 is displayed in the UI area 703 as an example.

The slide bar 704 is a UI area for setting whether to “suppress” or “emphasize” a tic response of a user when an avatar is to reflect the tic response of the user. Moving a pointer 706 on the slide bar 704 to the left “suppresses” the tic response of the user. Moving the pointer 706 to the right “emphasizes” the tic response of the user.

FIG. 7A represents an example in which the degree of reflection of a motor tic response of the patient A in the avatar is set to neither “suppress” nor “emphasize”. FIG. 7B represents an example in which the degree of reflection of a motor tic response of the patient A in the avatar is set to “suppress”. FIG. 7C represents an example in which the degree of reflection of a motor tic response of the patient B in the avatar is set to “emphasize”.

Note that instead of the counselor setting the degree of reflection using the setting UI 701 as described above, the CPU 306 may automatically set the degree of reflection according to disease information of a patient. For example, the milder the symptoms indicated by the disease information of the patient, the greater the degree to which the CPU 306 reflects the physical information related to the disease information in the avatar of the patient. Accordingly, the time and effort required for a user to set a degree of reflection can be reduced.

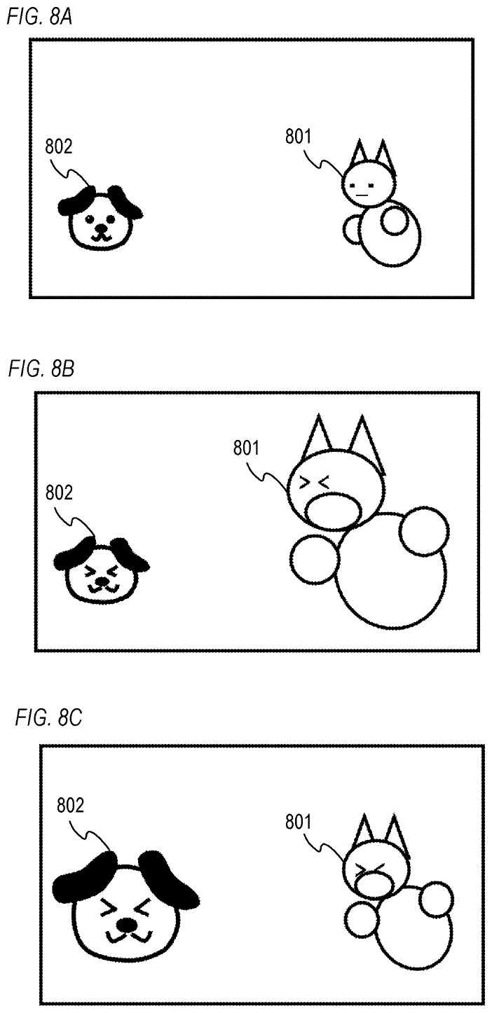

FIGS. 8A to 8C are diagrams representing an avatar of the patient A and an avatar of the patient B as displayed on the user terminal 102 of a main counselor. An avatar 801 is the avatar of the patient A and an avatar 802 is the avatar of the patient B. FIG. 8A represents the two avatars displayed when both the patient A and the patient B are not experiencing motor tics.

FIG. 8B represents the two avatars when a motor tic occurs simultaneously in the patient A and the patient B in a case where the degree of reflection of the response to the avatars of the patient A and the patient B is set to neither “suppress” nor “emphasize” as shown in FIG. 7A. In this case, FIG. 8B shows that a motor tic response of the patient A is severe and a motor tic response of the patient B is mild.

FIG. 8C represents the two avatars in a state where the degree of reflection of the response to the avatar is set to “suppress” in the UI of the patient A in FIG. 7B and the degree of reflection of the response to the avatar is set to “emphasize” in the UI of the patient B in FIG. 7C. The two avatars are displayed with the avatar of the patient A smaller in size and the avatar of the patient B larger in size as compared to the case shown in FIG. 8B. Therefore, a display that makes occurrences of motor tics of the patient A and the patient B more noticeable is achieved.

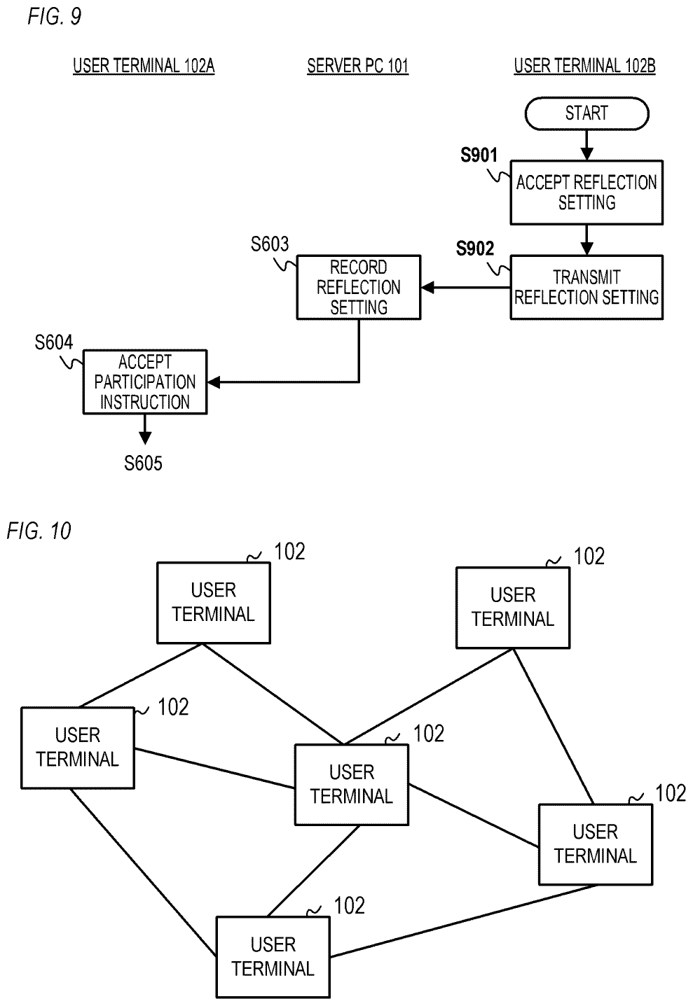

Next, processing according to the second embodiment will be described by using FIG. 9 with reference to the flow chart in FIG. 9. In the flow chart shown in FIG. 9, steps S601 and S602 in the flow chart shown in FIG. 6A are replaced by steps S901 and S902 while steps S603 and thereafter are the same as in the flow chart shown in FIG. 6A. Therefore, only steps S901 and S902 will be described.

In step S901, the CPU 201B of the user terminal 102B accepts a reflection setting indicating a degree of reflection of physical information (including symptoms) of the first user in an avatar of the first user. In this case, when the second user sets the degree of reflection of the physical information of the first user in the avatar of the first user to “emphasize” or “suppress” using the UI shown in FIG. 7A, the CPU 201B accepts the setting as the reflection setting.

In step S902, the CPU 201B transmits information on the reflection setting to the server PC 101.

According to the above, a user who actually views an avatar can set a degree of reflection of physical information to an avatar of another user. In addition, when setting an avatar to reflect a motion or voice of another user, it is also possible to set, for each user, which motion or voice is to be emphasized or suppressed and by how much.

### Third Embodiment

In the first and second embodiments, a communication system that is a client-server system connecting the server PC 101 and a plurality of user terminals 102 has been described. However, a communication system can also be realized by a system that does not include the server PC 101. In consideration thereof, in the third embodiment, a case where the communication system described in the first embodiment is constructed with a system that does not involve the server PC 101 will be described. Note that the communication system described in the second embodiment can also be constructed with a system that does not involve the server PC 101.

FIG. 10 is a system configuration diagram of a communication system according to the third embodiment. The communication system includes a plurality of user terminals 102 connected P2P (Peer to Peer) by a network such as the Internet. Since each of the plurality of user terminals 102 shown in FIG. 10 shares the same configuration as the user terminal 102 according to the first embodiment, a detailed description will not be provided. In addition, a setting UI according to the third embodiment is the same as the setting UI 401 according to the first embodiment described with reference to FIG. 4.

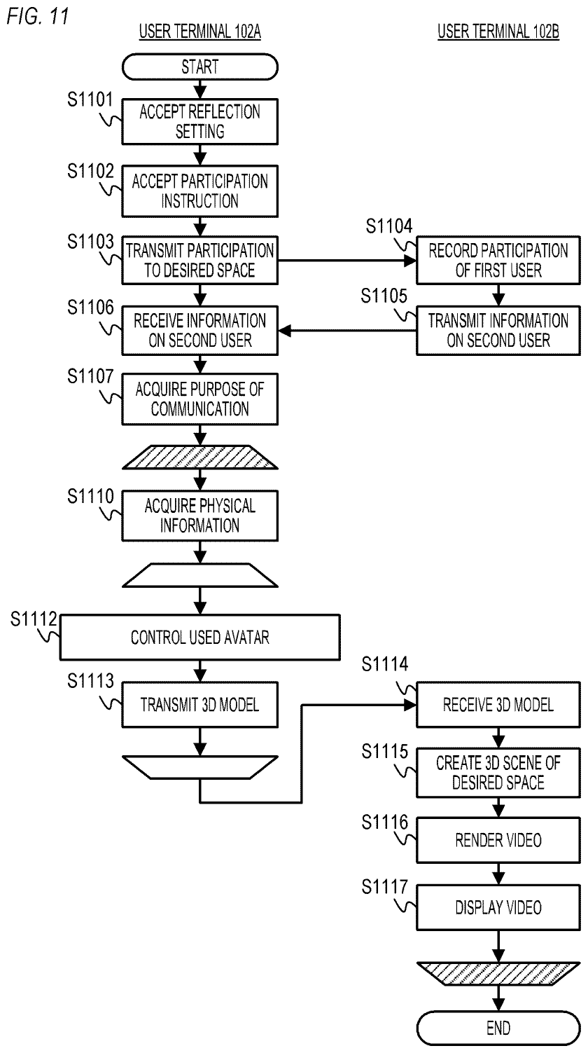

FIG. 11 is a flow chart representing processing by the communication system according to the third embodiment.

In step S1101, the CPU 201A of the user terminal 102A of the first user accepts a reflection setting from the first user in a similar manner to step S601.

The subsequent steps S1102 to S1106 represent processing by the first user to join a community in a desired space (virtual space). Although omitted in FIG. 11, the processing is executed between the user terminal 102A of the first user and user terminals 102 of all other users who join the community in the desired space.

In step S1102, the CPU 201A accepts a participation instruction from the first user to join the community in the desired space and acquires identification information of the desired space in a similar manner to step S604.

In step S1103, the CPU 201A transmits the identification information of the desired space to the user terminal 102B (the user terminal 102 of a counterpart user) in a similar manner to step S605. Accordingly, the CPU 201A notifies that the first user is to join the community in the desired space.

In step S1104, the CPU 201B records that the first user has joined the community in the desired space.

In step S1105, the CPU 201B transmits information related to the second user to the user terminal 102A. The information related to the second user includes information on a role of the second user. Acquisition of the role of the second user can be realized by a similar method to step S611.

In step S1106, the CPU 201A receives the information related to the second user.

In step S1107, the CPU 201A acquires a purpose of communication to be performed in the desired space in a similar manner to step S610.

Processing of subsequent steps S1110 to S1117 is loop processing which is repeated until all users including the first user leave the community in the virtual space.

In step S1110, the CPU 201A acquires real-time (present) physical information of the first user in a similar manner to step S607.

Processing of steps S1112 to S1113 is repeated as many times as the number of second users other than the first user participating in the community in the desired space (the number of the user terminals 102B communicating with the user terminal 102A).

In step S1112, the CPU 201A controls the used avatar of the first user based on the physical information of the first user, the purpose of communication, and information on the second user in a similar manner to step S612.

In step S1113, the CPU 201A generates a 3D model of the used avatar controlled in step S1112 and transmits the generated 3D model to the user terminal 102B.

In step S1114, the CPU 201B receives the 3D model of the avatar of the first user.

In step S1115, the CPU 201B generates a 3D scene of the desired space including the avatar of the first user. The CPU 201B generates the 3D scene in a data format such as X3D that is capable of describing three-dimensional computer graphics.

In step S1116, the CPU 201B renders the 3D scene of the desired space generated in step S1115 and generates a frame of a video of the desired space as viewed from a viewpoint of the second user.

In step S1117, the CPU 201B displays the generated video of the desired space on the display 202B.

As described above, according to the third embodiment, reflection of physical information in an avatar can be controlled more appropriately even in a communication system that does not include the server PC 101 (server).

### Fourth Embodiment

In a fourth embodiment, a communication system changes (updates) information necessary to control an avatar according to a virtual space of a community in which a user participates.

In the fourth embodiment, the communication system is configured as described with reference to FIGS. 1 to 3 in a similar manner to the first embodiment. In the fourth embodiment, the communication system estimates an emotion of a user based on acquired physical information and reflects the estimated emotion in a facial expression of an avatar of the user. Note that “physical information” according to the fourth embodiment is assumed to be information other than emotion.

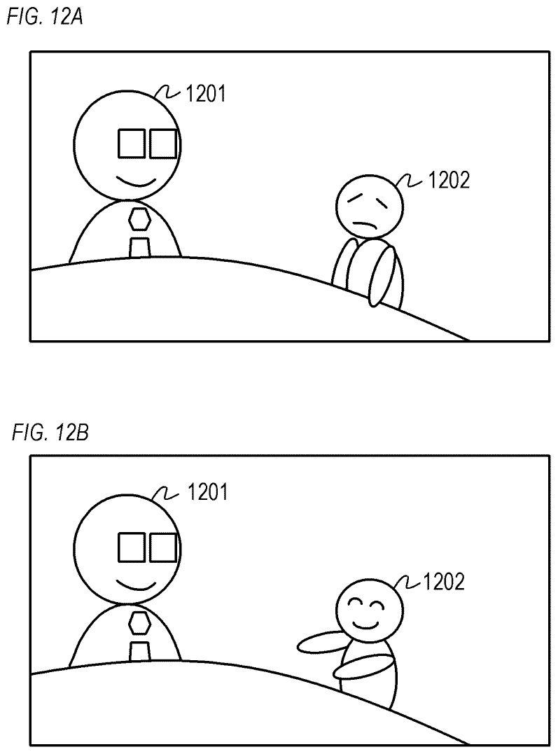

FIGS. 12A and 12B are diagrams representing an appearance of avatars of participants who are participating in the communication system. As an example, let us assume a case where a plurality of participants are engaged in a business negotiation using a virtual space. A negotiation counterpart A, a negotiation counterpart B, and a user C who is a presenter are participating in the business negotiation. Ranges of virtual spaces displayed on the user terminals 102 of the negotiation counterpart A, the negotiation counterpart B, and the user C differ from each other. For example, FIGS. 12A and 12B represent the virtual space displayed on the user terminal 102 of the negotiation counterpart B. In this case, an avatar 1201 is the avatar of the negotiation counterpart A and an avatar 1202 is the avatar of the user C.

FIGS. 12A and 12B represent an example where, due to an estimation of emotion based on physical information, it is estimated that the user C who is the presenter is feeling anxious and tense.

FIG. 12A is a diagram describing a display of the user terminal 102 when processing for changing physical information according to the fourth embodiment is not performed (when acquired physical information is used for emotion estimation as is). In the virtual space displayed on the user terminal 102 of the negotiation counterpart B, as shown in FIG. 12A, since the user C is experiencing emotions of anxiety and tension in real space, the emotions are also reflected in the facial expression of the avatar 1202.

On the other hand, FIG. 12B is a diagram describing a display of the user terminal 102 when processing for changing physical information according to the fourth embodiment is performed (when the acquired physical information is changed and, subsequently, the changed physical information is used for emotion estimation). In the virtual space displayed on the user terminal 102 of the negotiation counterpart B, the anxiety and tension of the user C are not reflected in the facial expression of the avatar 1202 of the user C (the anxiety and tension are suppressed).

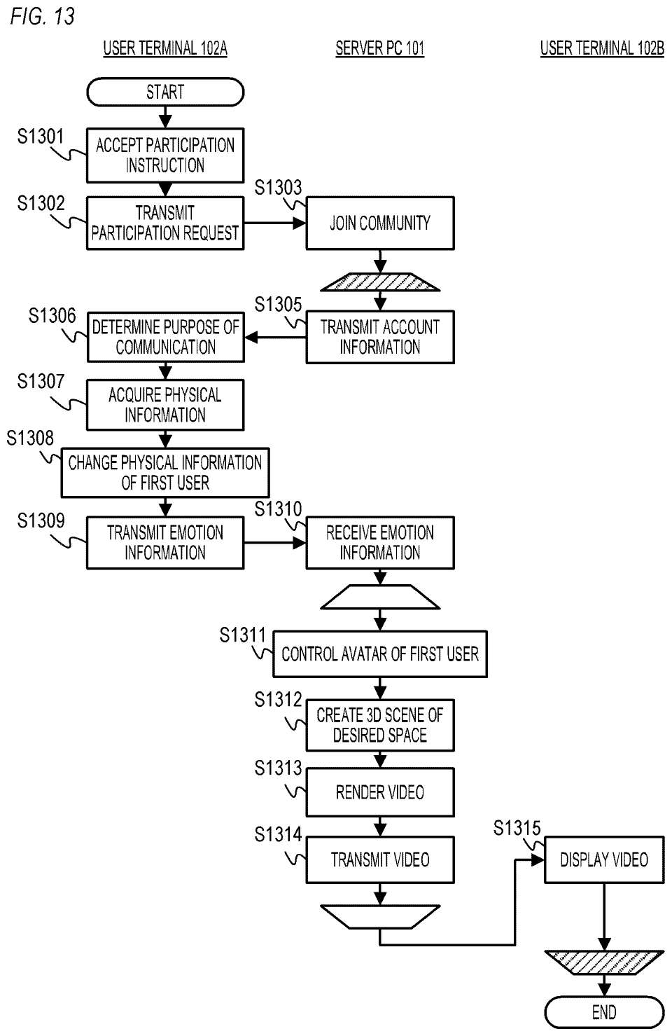

FIG. 13 is a flow chart representing processing by the communication system according to the fourth embodiment. The processing represented by the flow chart in FIG. 13 is processing using a remote rendering method in a similar manner to FIG. 6A. Note that the communication system according to the fourth embodiment can also be realized using the local rendering method described in FIG. 6B.

The processing represented by the flow chart in FIG. 13 is realized by the CPU 201 by controlling respective units of the user terminal 102 in accordance with a program stored in the ROM 203.

Steps S1301 to S1303 represent processing by the first user to join a community in virtual space. The processing is executed between the user terminal 102 of all users who join the virtual space and the server PC 101.

In step S1301, the CPU 201A accepts a participation instruction from the first user to join the virtual space. In doing so, the CPU 201A acquires identification information of the virtual space (desired space) which the first user desires to join.

In step S1302, the CPU 201A transmits the identification information of the desired space to the server PC 101 to make a request for participation in the community in the virtual space to the server PC 101.

In step S1303, the CPU 306 of the server PC 101 enlists the first user to the community in the desired space which corresponds to the identification information.

Processing of subsequent steps S1305 to S1315 is loop processing which is repeatedly executed until all users including the first user leave the community in the virtual space.

In step S1305, the CPU 306 transmits information on accounts of all users participating in the community in the desired space to the user terminal 102A.

In step S1306, the CPU 201A determines a purpose of communication. For example, the CPU 201A determines the purpose of communication based on information on a tool being used by the first user in the desired space. For example, when the first user is using a presenter tool, the CPU 201A can determine that the purpose of communication is to hold a meeting (presentation).

In addition, in step S1306, the CPU 201A further acquires (determines) information (related information) which is related to the communication. Note that the related information may be understood to be included in the purpose of communication.

(1) For example, the CPU 201A determines a role (position) of the first user based on information on a tool being used by the first user in the desired space. When the first user is using a presenter tool, the CPU 201A can determine that the first user is a presenter.

(2) For example, when the purpose of communication is to hold a meeting, the CPU 201A determines a type of the meeting (a relationship among a plurality of users to participate in the meeting) based on accounts of the users participating in a community in the desired space. For example, the CPU 201A determines whether the type of the meeting to be held is a meeting with a business partner, an internal meeting of a company, or a meeting with a friend. Identification information of user accounts registered in the user terminal 102 or the server PC 101 (virtual space) is used to determine the type of the meeting. Note that in step S1308 to be described later, in accordance with the type of the meeting (a relationship among the plurality of users participating in the meeting), the CPU 201A changes physical information of the first user acquired in step S1307 to be described later.

(3) For example, the CPU 201A determines nationalities of the participants based on accounts of the users participating in a community in the desired space. Identification information of user accounts registered in the user terminal 102 or the server PC 101 (virtual space) is used for the determination. Note that in step S1308 to be described later, in accordance with the nationalities of the participants, the CPU 201A changes physical information of the first user acquired in step S1307.

(4) For example, based on information on an event to be conducted in the desired space (in a platform in the desired space), the CPU 201A determines contents of the event. Note that when the contents of the event is to conduct a speech meeting or engage in a business negotiation, in step S1308 to be described later, the CPU 201A changes physical information of the first user acquired in step S1307.

In step S1307, the CPU 201A acquires the physical information of the first user.

Furthermore, the CPU 201A determines emotion information of the first user based on the acquired physical information (emotion determination). For example, a correspondence relationship between an output result of physical information and an emotion is verifiably obtained in advance and a table showing the correspondence relationship is stored in the ROM 203 or in the server PC 101. The CPU 201A determines whether acquired physical information matches a specific emotion pattern described in the table to determine the emotion information of the first user.

In step S1308, based on the purpose of communication and the related information determined in step S1306, the CPU 201A controls the physical information of the first user acquired in step S1307.

(1) For example, let us assume a case where the CPU 201A determines that the purpose of communication is to hold a meeting and that the first user is a presenter (a case where the CPU 201A determines that the purpose of communication is to hold a meeting in which the first user is a presenter). In this case, the CPU 201A changes the physical information of the first user so that “a tense facial expression or gesture in emotion determination is suppressed”. For example, when information on blood pressure or heart rate is acquired as physical information, the CPU 201A lowers the blood pressure or the heart rate by a prescribed value.

(2) For example, let us assume a case where the CPU 201A determines that the purpose of communication is to hold a meeting and that a type of meeting is a meeting with a business partner (the purpose of communication is to hold a meeting with a business partner). In this case, the CPU 201A changes the physical information of the first user so that “a tense facial expression or gesture in emotion determination is suppressed”.

(3) For example, let us assume a case where the CPU 201A determines that the purpose of communication is to hold a meeting and that a type of meeting is a meeting with a friend (the purpose of communication is to hold a meeting with a friend). In this case, the CPU 201A does not change the physical information of the first user.

(4) For example, let us assume a case where the CPU 201A determines that the purpose of communication is to hold a meeting and that users of a plurality of nationalities are to participate in the meeting (the purpose of communication is to hold a meeting in which users of a plurality of nationalities are to participate). In this case, the CPU 201A changes the physical information of the first user so that “a tense facial expression or gesture in emotion determination is suppressed and smiles are emphasized”. For example, when a stress level is acquired as physical information, the CPU 201A lowers the stress level by a prescribed value so that smiles are to be emphasized in emotion determination. Alternatively, when information on a motion is acquired as physical information, the CPU 201A emphasizes information of a motion of opening the mouth so that smiles are to be emphasized in emotion determination.

(5) For example, let us assume a case where the CPU 201A determines that the purpose of communication is to hold a meeting and that contents of the meeting is to conduct a lecture meeting or engage in a business negotiation (the purpose of communication is to conduct a lecture meeting or engage in a business negotiation). In this case, the CPU 201A changes the physical information of the first user so that “a tense facial expression or gesture in emotion determination is suppressed”.

(6) For example, let us assume a case where the CPU 201A determines that the purpose of communication is to play a game and that a type of the game is a game that requires a poker face (the purpose of communication is to play a particular game). In this case, the CPU 201A changes the physical information of the first user so that “a tense facial expression or gesture in emotion determination is suppressed”.

In step S1309, the CPU 201A determines an emotion of the first user based on the physical information of the first user controlled in step S1308 (performs emotion determination once again). The CPU 201A transmits information on the emotion of the first user to the server PC 101.

In step S1310, the CPU 306 receives the information on the emotion of the first user.

Processing of subsequent steps S1311 to S1314 is loop processing which is repeated as many times as the number of second users who participate in the desired space and view a video of the desired space.

In step S1311, the CPU 306 controls the used avatar of the first user based on the information on the emotion of the first user received in step S1310. For example, the CPU 306 controls the facial expression or the motion (gesture) of the used avatar so as to reflect the emotion of the first user.

Since steps S1312 to S1315 are similar to steps S613 to S616 according to the first embodiment, a detailed description will not be repeated.

As described above, according to the fourth embodiment, the facial expression and the like of an avatar can be adjusted to a facial expression and the like in alignment with the purpose of communication.

Note that in step S1308, when the physical information acquired in step S1307 satisfies a particular condition, the CPU 201A may issue a warning (notification) to the first user. For example, when the CPU 201A determines that a negative emotion value (an emotion value of anxiety and the like) indicated by the emotion in accordance with the physical information exceeds a threshold, the CPU 201A may issue a warning (notification) to the first user. Alternatively, when the CPU 201A determines that a value (for example, a blood pressure, a heart rate, or a body temperature) indicated by the physical information acquired in step S1307 exceeds a threshold, the CPU 201A may issue a warning (notification) to the first user. In this case, for example, the CPU 201A inquires “may the physical information be transmitted” or “may the physical information be changed” by issuing a warning to the first user before transmitting the physical information to the server PC 101 in step S1309. The CPU 201A may display a display item that indicates a warning on the display 202 or output sound that indicates a warning from the speaker 211.

While whether or not a warning is to be issued is determined based on the physical information before changing (controlling) the physical information in step S1308, alternatively, a warning may be issued based on the physical information after the change is made in step S1308.

Note that while the user terminal 102A changes the physical information of the user in step S1308 so that an emotion determination can be made based on the purpose of communication and the like, alternatively, the emotion information may be changed directly based on the purpose of communication and related information.

In the fourth embodiment, the user terminal 102A sends emotion information determined based on the physical information of the user to the server PC 101. However, the server PC 101 may perform an emotion determination of the user and control the facial expression of the avatar based on the physical information of the user transmitted by the user terminal 102A.

As described above, according to the fourth embodiment, emotion information is controlled based on the purpose of communication in a virtual space. Accordingly, for example, as shown in FIG. 12B, anxiety and tension are not expressed and a facial expression of calmness appears on the avatar 1202 of the user C in the virtual space that is viewed by the negotiation counterpart B. In other words, the communication system can display an avatar with a more appropriate facial expression in a business negotiation.

In addition, “advance to step S1 when A is B or more but advance to step S2 when A is smaller (lower) than B” in the description presented above may be replaced with “advance to step S1 when A is larger (higher) than B but advance to step S2 when A is B or less”. Conversely, “advance to step S1 when A is larger (higher) than B but advance to step S2 when A is B or less” may be replaced with “advance to step S1 when A is B or more but advance to step S2 when A is smaller (lower) than B”. Therefore, unless an inconsistency arises, the expression “A or more” may be replaced with “A or larger (higher; longer; more) than A” or replaced with “larger (higher; longer; more) than A”. On the other hand, the expression “A or less” may be replaced with “A or smaller (lower; shorter; less) than A” or replaced with “smaller (lower; shorter; less) than A”. In addition, “larger (higher; longer; more) than A” may be replaced with “A or more” and “smaller (lower; shorter; less) than A” may be replaced with “A or less”.

While the present invention has been described in detail based on preferred embodiments thereof, the present invention is not limited to the specific embodiments and various modes without departing from the scope of the invention are also included in the present invention. Parts of the embodiments described above may be appropriately combined with each other.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

According to the present invention, reflection of user information in an avatar can be more appropriately controlled.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A system for realizing communication between a first user and a second user, the system comprising:
one or more processors and/or circuitry configured to:
execute acquiring processing of acquiring real-time information of the first user; and
execute control processing of controlling, on a display apparatus which belongs to the second user and which displays a virtual space including a first avatar of the first user, reflection of the real-time information of the first user in a facial expression of the first avatar, wherein
in the control processing, the real-time information of the first user is reflected in the facial expression of the first avatar by emphasizing or suppressing the real-time information based on at least one of a purpose of the communication and information on the second user.

2. The system according to claim 1, wherein
the real-time information includes information about a body.

3. The system according to claim 2, wherein
the real-time information includes information of at least one of voice, facial expression, blood pressure, heart rate, stress level, body temperature, perspiration, brain waves, pulse rate, posture, and motion.

4. The system according to claim 1, wherein
in the control processing, an image of a virtual space including the first avatar is generated and the display apparatus is controlled so as to display the image of the virtual space.

5. The system according to claim 1, wherein
in the control processing, reflection of the real-time information of the first user in the facial expression of the first avatar is controlled based on a reflection setting configured by the first user or the second user and the purpose of the communication, and
the reflection setting is a setting which associates the purpose of the communication and a degree of reflection of the real-time information of the first user in the facial expression of the first avatar with each other.

6. The system according to claim 1, wherein
in the control processing, reflection of the real-time information of the first user in the facial expression of the first avatar is controlled based on disease information of the first user.

7. The system according to claim 6, wherein
in the control processing:
it is determined whether or not a symptom indicated by the disease information has occurred in the first user based on the disease information of the first user and the real-time information of the first user; and
reflection of the real-time information of the first user in the facial expression of the first avatar is controlled based on a determination result as to whether or not the symptom has occurred.

8. The system according to claim 1, wherein
in the control processing, the purpose of the communication is determined based on information forming the virtual space.

9. The system according to claim 1, wherein
in the control processing, the purpose of the communication is determined based on information on an account or an avatar of at least one of a plurality of users participating in a community in the virtual space.

10. The system according to claim 1, wherein
in the control processing, the purpose of the communication is determined based on information on a tool used by the first user.

11. The system according to claim 1, wherein
the purpose of the communication is a purpose entered by at least one of a plurality of users participating in a community in the virtual space.

12. The system according to claim 1, wherein
in the control processing, reflection of the real-time information of the first user in the facial expression of the first avatar is controlled based on nationalities of a plurality of users participating in a community in the virtual space.

13. The system according to claim 1, wherein
in the control processing, reflection of the real-time information of the first user in the facial expression of the first avatar is controlled based on a relationship among a plurality of users participating in a community in the virtual space.

14. The system according to claim 1, wherein
in the control processing, reflection of the real-time information of the first user in the facial expression of the first avatar is controlled based on a role of the second user.

15. The system according to claim 14, wherein
in the control processing, information on the role of the second user is acquired based on information on an account of the second user.

16. The system according to claim 14, wherein
in the control processing, information on the role of the second user is acquired based on an operation by the first user.

17. The system according to claim 1, wherein
in the control processing, information on the role of the second user is acquired from an external system.

18. The system according to claim 1, wherein
the one or more processors and/or circuitry further executes warning processing of issuing a warning to the first user in a case where the real-time information of the first user satisfies a particular condition before reflecting the real-time information of the first user in the facial expression of the first avatar.

19. A system control method for realizing communication between a first user and a second user, the system control method comprising:
acquiring real-time information of the first user; and
controlling, on a display apparatus which belongs to the second user and which displays a virtual space including a first avatar of the first user, reflection of the real-time information of the first user in a facial expression of the first avatar, wherein
the real-time information of the first user is reflected in the facial expression of the first avatar by emphasizing or suppressing the real-time information based on at least one of a purpose of the communication and information on the second user.

20. A non-transitory computer readable medium that stores a program, wherein the program causes a computer to execute A system control method for realizing communication between a first user and a second user, the system control method comprising:
acquiring real-time information of the first user; and
controlling, on a display apparatus which belongs to the second user and which displays a virtual space including a first avatar of the first user, reflection of the real-time information of the first user in a facial expression of the first avatar, wherein
the real-time information of the first user is reflected in the facial expression of the first avatar by emphasizing or suppressing the real-time information based on at least one of a purpose of the communication and information on the second user.
